(19) United States
(12) Patent Application Publication
(10) Pub. No.: US 2024/0097170 A1
(43) Pub. Date: Mar. 21, 2024

(54) Mixed electron-proton conductor gas diffusion electrode based hybrid Co2 electrochemical reducer and hydrogen fuel cell system

(71) Applicant: Yonghua Wang, Klamath Falls, OR (US)

(72) Inventor: Yonghua Wang, Klamath Falls, OR (US)

(21) Appl. No.: 17/803,644

(22) Filed: Sep. 17, 2022

(51) Int. Cl. H01M 8/0656; H01M 8/0612

(52) U.S. Cl. CPC H01M 8/0656; H01M 8/0612

(57) ABSTRACT

A mixed electron-proton conductor gas diffusion electrode based hybrid CO2 electrochemical reducer and hydrogen fuel cell system reduces CO2 into CO while generating electric power by consuming hydrogen and oxygen generated from renewable energy powered water electrolysis system. The hybrid CO2 electrochemical reducer and hydrogen fuel cell system includes a gas diffusion electrode made of mixed electron-proton conductors such as modified single-wall carbon nano-tubes working at room temperature to pass electrons and protons generated from hydrogen and CO2 to facilitate CO2 reduction.

### TECHNICAL FIELD

The present disclosure relates generally to a hybrid CO2 electrochemical reducer and hydrogen fuel cell system, more specifically, to mixed electron-proton conductor gas diffusion electrode based hybrid CO2 electrochemical reducer and hydrogen fuel cell system.

### BACKGROUND

The modern society of the world is facing to 2 grand challenges global warming and fossil fuel depletion. Apparently, it is well know that if the entire world completely transfers to renewable energies such as solar energy, then there is no any anxiety on global warming and fossil fuel depletion. Unfortunately, due to intermittence of renewable energy resources, current renewable energy technologies are unable to fulfill this mission to power the entire world. In reality, renewable energies are not even the main stream of power supply of the modern society.

Carbon based fossil fuels are approved to be the best mediums of solar energy storage, however it takes millions of years to turn the solar energy accumulated into plants and animals into fossil fuels and the modern usage of fossil fuel emits the green house gas carbon dioxide. Therefore, the modern society is facing to the grant challenges of fossil fuel depletion and global warming. In order to address the energy crisis and curb the climate change, the entire world scrambles in searching solution to address the issues caused by fossil fuel consumption and carbon dioxide (CO2) emission. One of the most desirable approaches in dealing with CO2 is turning it into liquid fuel by using renewable energy. The approach provides a radical solution to address the global warming, fossil fuel depletion, and renewable energy storage triple issues in one strike, meaning “one stone three birds”. One of the pathways in transforming CO2 into liquid fuel methanol includes two steps: 1) electrochemically reduce CO2 into CO by deploying electric power generated by using solar energy or using hydrogen generated by using solar energy; 2) synthesize CO and hydrogen generated through electrolysis of water using solar generated electric power into liquid methanol.

U.S. Pat. No. 8,138,380 B2 granted to Olah et al discloses an apparatus converting carbon dioxide by an electrochemical reduction of carbon dioxide in a divided electrochemical cell that includes an anode in one compartment and a metal cathode electrode in a compartment that also contains an aqueous solution comprising methanol and an electrolyte. An anion-conducting membrane can be provided between the anode and cathode to produce at the cathode therein a reaction mixture containing carbon monoxide and hydrogen, which can be subsequently used to produce methanol while also producing oxygen in the cell at the anode.

EP. Pat. No. 3358042 B1 granted to Kudo et al discloses an electrolysis cell and electrolytic device for carbon dioxide providing an electrolysis cell and electrolytic device for carbon dioxide which make it possible to suppress a variation in a cell voltage in an electrolytic reaction of carbon dioxide.

In prior arts, CO2 is reduced into CO mainly either through electrochemical electrolysis of CO2 or CO2 and hydrogen reaction under high pressure and high temperature.

Recently, Matsuda et al (Shofu Matsuda, Yuuki Niitsuma, Yuta Yoshida & Minoru Umeda, H2-CO2 polymer electrolyte fuel cell that generates power while evolving CH4 at the Pt0.8Ru0.2/C cathode, Nature, Scientific Reports volume 11, Article number: 8382 (2021)) reports a hydrogen fuel cell system with oxygen replaced with CO2 at cathode side, so that the CO2 is reduced while generating electric power. The system employs hydrogen to generate electricity and reduce CO2. However, in contrast to other electrochemical CO2 reduction systems, the Faraday Efficiency of this system is low. Furthermore, this system makes use of only one product of water electrolysis the hydrogen rather than both of hydrogen and oxygen. In other words, it does not take advantage of the strong oxidant oxygen to facilitate the reduction of CO2.

The present invention discloses a mixed electron-proton conductor gas diffusion electrode based hybrid CO2 electrochemical reducer and hydrogen fuel cell system that employs both hydrogen and oxygen generated from renewable energy powered water electrolysis system to reduce CO2 while generating electric power. This system incorporates a mixed electron-proton conductor gas diffusion electrode into the anode of fuel cell system to enhance CO2 reduction by shortening electron and proton paths toward CO2 reducer so as to raise Faraday Efficiency of the system.

In conventional approach to liquid fuel from CO2, renewable energy generated electric power is employed to reduce CO2 into CO and split H2O into hydrogen and oxygen, then the CO and hydrogen are synthesized into methanol. In the disclosure of the present invention, the solar power generated hydrogen and oxygen are employed to drive fuel cell to generate electric power and simultaneously reduce CO2 into CO, then the CO and hydrogen are synthesized into methanol.

The characteristics of the present invention will become more apparent as the present description proceeds.

### Objects

The objects of this invention are to: (1) provide a design paradigm for a mixed electron-proton conductor gas diffusion electrode based hybrid CO2 electrochemical reducer and hydrogen fuel cell system that can generate electric power by consuming hydrogen and oxygen; (2) provide a mechanism that can be incorporated into fuel cell to reduce CO2 into CO; (3) provide a mechanism that can increase Faraday Efficiency of CO2 reduction system.

### SUMMARY

In the prior arts, CO2 is reduced by electrons provided by external circuit and power sources in an electrolysis cell normally with liquid electrolyte. The limited solubility of CO2 in liquid electrolyte detriments the performance of the electrolysis system on reducing CO2. The present invention discloses an apparatus that employs the protons and electrons generated on the anode of the fuel cell, in conjunction with a gas diffusion electrode made of mixed electron-proton conductor to pass by electrons and protons, as well as CO2 gas, to reduce CO2 into CO. In this disclosure, the hydrogen and oxygen generated from water electrolysis system powered by renewable energies are all used to drive fuel cell to generate electric power and simultaneously reduce CO2 into CO.

Further aspects and advantages of the present invention will become apparent upon consideration of the following description thereof, reference being made of the following drawing.

### BRIEF DESCRIPTION OF THE DRAWINGS

The accompanying drawings, which are incorporated in and constitute a part of this specification, illustrate an embodiment of the invention and together with the description, serve to explain the principles of the invention.

FIG. 1 is the schematic diagram of the hydrogen and oxygen driven electrochemical CO2 reduction and electric power generation system with a mixed electron-proton conductor gas diffusion electrode.

FIG. 2 is indication of structure of a stake of the mixed electron-proton conductor gas diffusion electrode based hybrid CO2 electrochemical reducer and hydrogen fuel cell system units.

FIG. 3 is indication of structure of a bipolar plate used in the mixed electron-proton conductor gas diffusion electrode based hybrid CO2 electrochemical reducer and hydrogen fuel cell system unit stake.

### DETAILED DESCRIPTION

Reference will now be made in detail to the present exemplary embodiments, examples of which are illustrated in the accompanying drawings. Wherever possible, the same reference numbers will be used throughout the drawings to refer to the same or like parts.

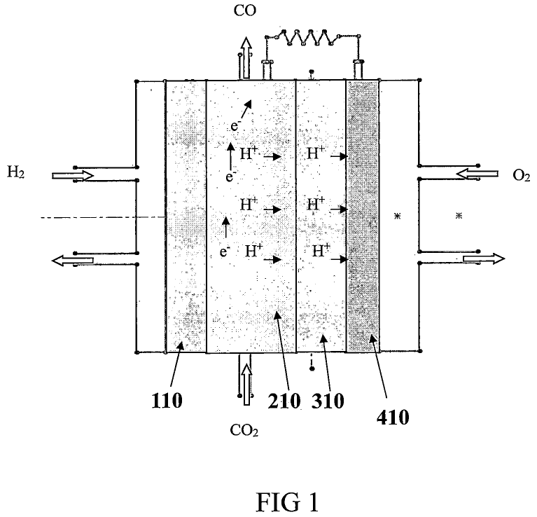

Referring to FIG. 1, the mixed electron-proton conductor gas diffusion electrode based hybrid CO2 electrochemical reducer and hydrogen fuel cell system comprises: 1) an anode cell chamber compartment 110; 2) a mixed electron-proton conductor gas diffusion electrode 210; 3) a proton exchange membrane 310; 4) a cathode cell chamber compartment 410. Wherein, the components 110, 210, 310, 410 of the system are connected in series; the electrodes 210 is connected to the cathode 410 through a external circuit.

Wherein, the following chemical reaction happens on the anode 110:
H=H⁺+e⁻; the following chemical reaction happens inside of the mixed electron-proton conductor gas diffusion electrode 210:
2H⁺+2e⁻+CO₂=CO+H₂O; the following chemical reaction happens on cathode 410:
2H⁺+2e⁻+O₂=2H₂O.

Wherein, the protons generated on the anode 110 penetrate through the mixed electron-proton conductor gas diffusion electrode to reduce the CO2 passing by the gas diffusion electrode; the residue of the electrons and protons pass by the external circuit and the proton exchange membrane 310 respectively to generate electric power.

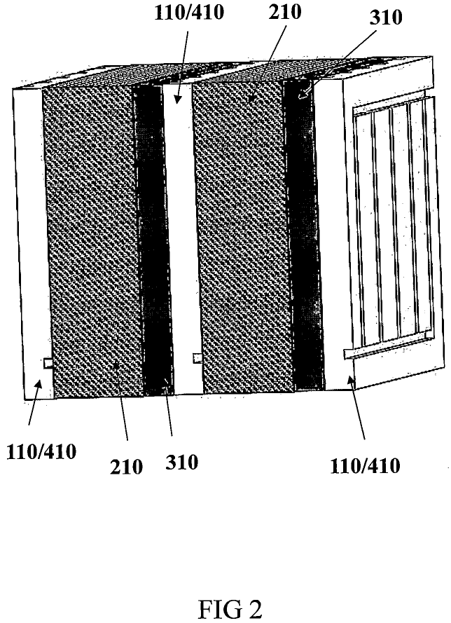

Referring to FIG. 2, the mixed electron-proton conductor gas diffusion electrode based hybrid CO2 electrochemical reducer and hydrogen fuel cell systems as units are connected in series into a stake with bipolar plates 110/410 to generate a high voltage.

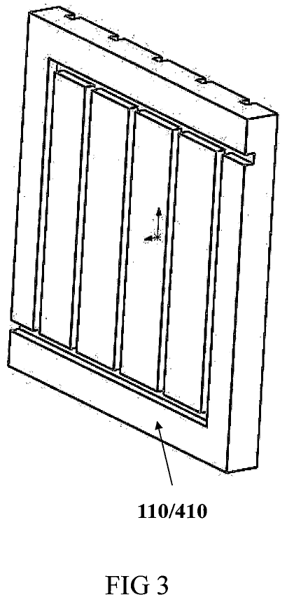

Referring to FIG. 3, the bipolar plates 110/410 serve as both anode and cathode.

From the description above, number of advantages of the multi-compartment hybrid CO2 electrochemical reducer and hydrogen fuel cell system become evident: 1) protons and electrons are readily available to reduce CO2 into CO; 2) the system generates electric power simultaneously; 3) all products of water electrolysis can be used for this process.

In the preceding specification, various preferred embodiments have been described with reference to the accompanying drawings. It will, however, be evident that various other modifications and changes may be made thereto, and additional embodiments may be implemented, without departing from the broader scope of the invention as set forth in the claims that follow. The specification and drawings are accordingly to be regarded in an illustrative rather than restrictive sense.

Other embodiments of the invention will be apparent to those skilled in the art from consideration of the specification and practice of the invention disclosed herein. It is intended that the specification and examples be considered as exemplary only, with the true scope and spirit of the invention being indicated by the following claims.

I claim:

1: A mixed electron-proton conductor gas diffusion electrode based hybrid CO2 electrochemical reducer and hydrogen fuel cell system comprises: 1) an anode cell chamber compartment; 2) a mixed electron-proton conductor gas diffusion electrode; 3) a proton exchange membrane; 4) a cathode cell chamber compartment, wherein, components of the system are connected in series; the mixed electron-proton conductor gas diffusion electrode is connected to the cathode through an external circuit; wherein, the following chemical reaction happens on the anode:
H=H⁺+e⁻; the following chemical reaction happens inside of the mixed electron-proton conductor gas diffusion electrode:
2H⁺+2e⁻+CO₂=CO+H₂O; the following chemical reaction happens on cathode 410:
2H⁺+2e⁻+O₂=2H₂O;
wherein, electrons and protons generated in the anode cell chamber compartment penetrate through the mixed electron-proton conductor gas diffusion electrode to reduce CO2 passing by the gas diffusion electrode; residue of the electrons and protons pass by the external circuit and the proton exchange membrane respectively to generate electric power.

2: The mixed electron-proton conductor gas diffusion electrode based hybrid CO2 electrochemical reducer and hydrogen fuel cell system of claim 1, wherein the mixed electron-proton conductor gas diffusion electrode can be made of modified single-wall carbon nanotubes.

3: The mixed electron-proton conductor gas diffusion electrode based hybrid CO2 electrochemical reducer and hydrogen fuel cell system of claim 1, wherein multiple such systems can be connected in series into a stake by using bipolar plates.
